(19) United States
(12) Patent Application Publication
(10) Pub. No.: US 2012/0068857 A1
(43) Pub. Date: Mar. 22, 2012

(54) CONFIGURABLE REMOTE CONTROL

(75) Inventors: Fletcher Rothkopf, Los Altos, CA (US); Stephen Brian Lynch, Portola Valley, CA (US)

(73) Assignee: Apple Inc., Cupertino, CA (US)

(21) Appl. No.: 12/887,745

(22) Filed: Sep. 22, 2010

(51) Int. Cl. G05B 19/02

(52) U.S. Cl. 340/870.07; 345/173

(57) ABSTRACT

An electronic device self-configurable for remote control functionality and related methods are disclosed herein. In particular, in one embodiment, a method for configuring a multifunctional electronic device to operate as a remote control is provided that includes capturing an image of an electronic device and comparing the image with data stored in a database. The manufacturer of the electronic device is determined based on one or more identifying characteristics in the captured image and information related to remote control of the electronic device is retrieved. The method also includes populating a screen of the multifunctional electronic device for remote control of the electronic device.

### FIELD OF INVENTION

The present disclosure relates to a remote control device and, more particularly, to a configurable remote control device.

### BACKGROUND

Some remote controls may be configurable to control multiple different electronic devices. Such remote controls are commonly referred to as “universal remote controls” as they consolidate the control of electronic devices into a single controller. Advanced universal remote controls may be capable of controlling dozens of devices, including audio and video equipment and home automations systems (e.g., lighting, door locks, and the like).

In order to achieve universal functionality, typically, universal remotes are programmed by a user. The programming may include looking up information either in a manual or online to find codes for infrared signals that will work for controlling the particular brand, model and/or type of electronic device being used by the user. Often multiple codes are given for a particular device and, as such, an iterative process of trial and error is used to find a correct code for a particular device with the user repeatedly looking up a code, entering the code into the remote and trying to control a device after the code has been entered. Thus, the process may be time-intensive and/or frustrating to a user.

### SUMMARY

A remote control device that is configurable to gather state information from a controlled components. In some embodiments, the remote control device may have one or more sensors to facilitate the state determination. For example, the remote control may have one or more cameras, microphones and/or other sensors. The sensors may be configured to operate upon actuation of the remote control device to determine if signals transmitted by the remote control were received and a desired result was achieved.

In some embodiments, the remote control may include a camera that is configured to capture an image of controlled devices. The image is then processed to find a state of the device. For example, in some embodiments, the image may be processed to determine shapes and/or characters on a television screen. The shapes and characters may be used to determine that the television is displaying content from a particular source.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and detailed description are to be regarded as illustrative in nature and not restrictive.

### BRIEF DESCRIPTION OF THE DRAWINGS

FIG. 1 illustrates an example electronic device that may be configurable to function as a universal remote control.

FIG. 2 is an example block diagram of the electronic device of FIG. 1.

FIG. 3 is a flow chart illustrating a method for configuring the electronic device to operate as a universal remote control.

FIG. 4 illustrates an example entertainment center including multiple devices that may be controlled by the electronic device of FIG. 1.

FIG. 5 illustrates a network accessible database that may be accessed to obtain information related to controlling a device.

FIG. 6 is a flow chart illustrating a method of configuring the electronic device of FIG. 1 to function as a remote control based on an image of a remote controller.

FIG. 7 illustrates an example of a remote controller of which an image may be captured for configuring the electronic device of FIG. 1 as a remote control.

FIG. 8 illustrates the electronic device of FIG. 1 displaying an image of the remote controller of FIG. 7.

FIG. 9 is a flow chart illustrating a method for determining an input configuration for an electronic device controlled by the electronic device of FIG. 1.

FIG. 10 is a flow chart illustrating a method for location based self-configuration of a control device.

FIG. 11 is a flow chart illustrating a method for providing supplementary content on a control device based on content being consumed from a controlled device.

### DETAILED DESCRIPTION

The present disclosure relates to a configurable remote control. In particular systems and techniques are disclosed related to an electronic device that is configurable as a universal remote control. In some embodiments, the electronic device may take the form of a dedicated universal remote control. In other embodiments, the electronic device may take the form of a portable media player, a smart phone, a personal digital assistant, a cell phone, or other electronic device that has been configured and/or programmed to function as a remote control. For example, in some embodiments, a portable media player may be configured with infrared (IR) emitting capabilities so that it may function as a remote control. As used herein, “control device” refers to the configurable electronic device that may function as a remote control.

In some embodiments, the control device may be configured to determine a set of IR codes that control other devices. The other devices may include devices such as a television, a digital video disc (DVD) player, a Digital Video Recorder (DVR), a receiver, a video game console, a cable box, and/or the like. In some embodiments, the control device may be configured to capture an image of the device to be controlled, recognize the device and self-configure to control the device, for example by obtaining IR codes for the device. In some embodiments, the self-configuration may be performed for multiple devices within a system. For example, the control device may be configured to determine the IR codes for each component device and then determine the configuration of the devices that are intended to operate together. Hence, if there are multiple inputs to a television, the control device may be configured to determine that a first device, such as a DVR, is input 1, a second device such as a DVD player is input two and third device such as a video game console is input three.

In some embodiments, the control device may be configured to capture an image of a dedicated remote controller for a device that is to be controlled, recognize the remote controller and obtain IR codes for controlling the device. In some embodiments, the control device may utilize the captured image of the remote controller and generate virtual buttons on a touch screen display for controlling the controlled device. As such, the control device may display buttons that are similar to those on an actual remote controller for the controlled device. In other embodiments, the control device may obtain a key or button configuration from a database that corresponds to the controlled device but may or may not resemble a dedicated remote controller for the controlled device.

In some embodiments, the control device may be configured to determine its location and self-configure based on the determination so that it may control devices in its proximity. For example, the control device may initially be configured to control a television located in a living room. The control device may be moved to another room in the house, such as a bedroom that has another television. The control device may determine that it is in a new location and further may determine that it is in proximity to a different device for which it is configured to control and self-configure to control the television in the bedroom.

In some embodiments, the control device may be configured to listen to the sound emitted from a controlled device to determine what device is proximately located to the control device and/or what content is being provided. For example, the control device may listen for particular queues such as a station identifier, show name and/or theme song, advertisements, or other provided content and from such information, determine what the content is. Upon determining the content that is being consumed by a user, the control device may provide additional content to a user via its display aimed at enhancing the user's experience with the content. For example, if the control device determines a particular movie is on, it may provide information similar to the information found on a movie jacket on its display or provide recommendations as to other movies that are within a genre of the movie.

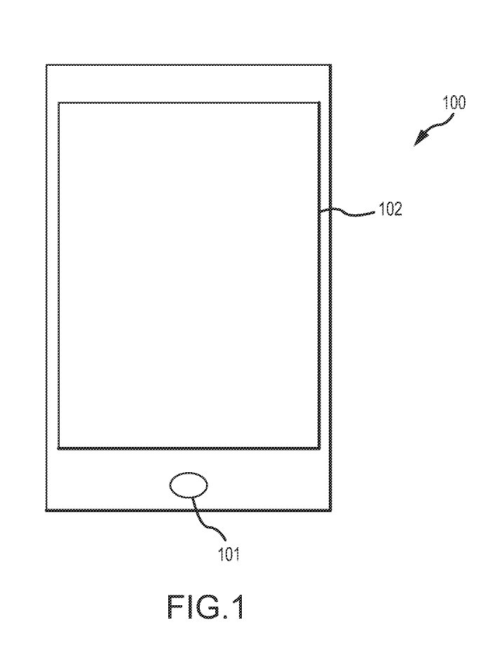

Turning to the drawings, FIG. 1 illustrates an example control device 100. Generally, the control device 100 may be any electronic device configured and/or configurable to control other electronic devices. For example, in some embodiments, the electronic device 100 may take the form of a smart phone configured with IR transmission capabilities. Typically, smart phones may be configured to perform a number of different functions for a user including voice and data communication, media playback, and camera functionality. In other embodiments, the control device 100 may take the form of a dedicated universal remote control. That is, the device is primarily a remote control device not configured to perform other functions. As will be discussed below, in some embodiments, the control device may utilize a microphone, a camera, or a light detector to determine the state of controlled devices.

The control device 100 may include one or more user interfaces to allow a user to provide input to the device. For example, the control device 100 may include one or more buttons 101, a scroll wheel, a trigger, a mouse pad, a keyboard, and/or other input devices. In some embodiments, as illustrated, the control device 100 may include a touch screen 102 to receive user input and/or display information to the user. The touch screen 102 may be configurable to display various different virtual buttons or virtual input modes to allow a user to issue commands to control other device.

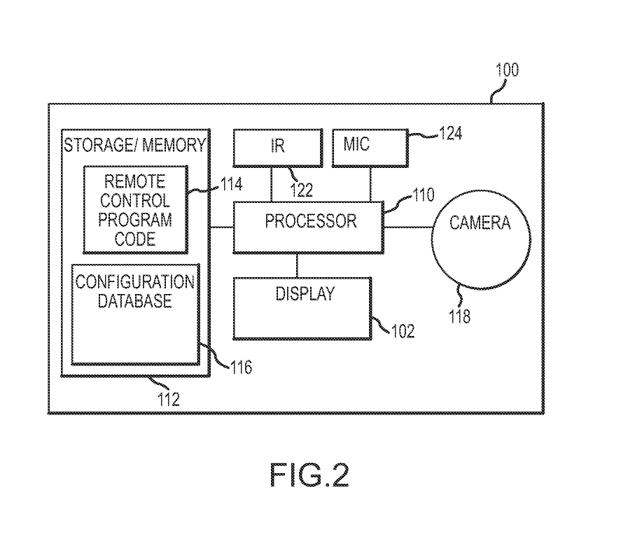

FIG. 2 is a block diagram illustration of the control device 100 showing various components. The control device 100 includes a processor 110 that may execute instructions and make determinations related to the state of controlled devices, for example. Additionally, the device 100 may include memory 112 coupled to the processor 110. The memory 112 may be configured to hold data, operating software and/or instructions for execution by the processor 110. For example, the memory 110 may include a remote control computer program 114 related to having the control device 100 function as a remote control. Additionally, in some embodiments, the memory 112 may include a database 116 that may store information related to various electronic devices that may be controlled and/or their dedicated remote controllers. For example, in some embodiments, the configuration database 116 may include data that is used for comparison purposes with data obtained using an input device such as a camera or microphone to identify the devices that are to be controlled. The memory 112 can take various forms including random access memory, read-only memory (ROM), electrically erasable programmable ROM, and/or combinations thereof.

The control device 100 may include one or more I/O ports and/or input devices to allow for collection of information related to the state of controlled devices. For example, the control device 100 may include a camera 118 and/or a microphone 120. Additionally, the device may include the display/touchscreen 102 and an IR device 122 for IR transmission capability. In some embodiments, the camera 118 and the IR device 122 may be mounted on a common face of the device so that as the control device 100 is aimed at controlled devices, it may capture images with the camera.

It should be appreciated that in some embodiments other modes of communicating commands may be implemented besides or in addition to IR. For example, in some embodiments, a radio frequency (RF) may be implemented with a corresponding protocol, such as Bluetooth®, or WiFi. As such, in some embodiments, the device 100 may include one or more RF antennas.

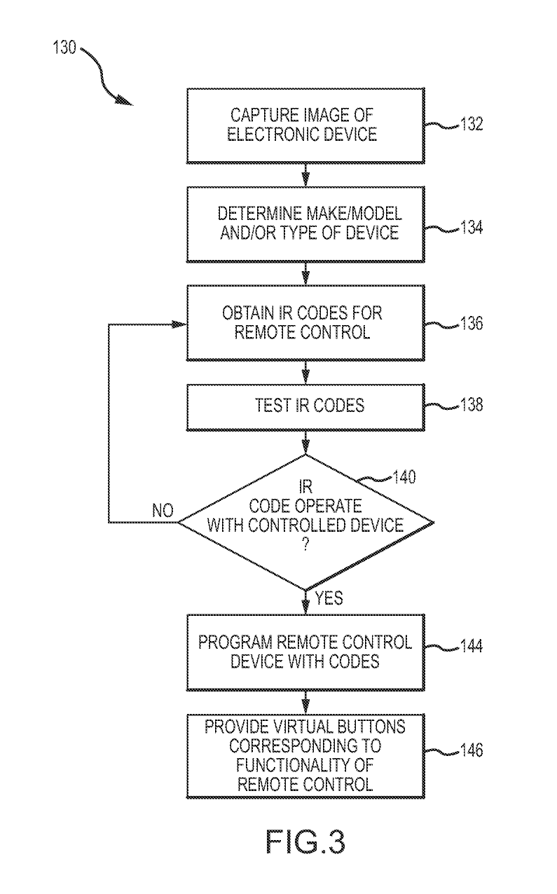

FIG. 3 is a flowchart illustrating an example method 130 for operating the control device to self-configure for controlling another device. The method may begin by obtaining an input that may be used to identify the electronic device that is to be controlled, such as by using image processing techniques to compare the captured image against a database of known devices. For example, the control device may capture an image of the electronic device (Block 132). The control device may then identify the device that is to be controlled. For example, the control device may determine the make and/or model and/or the type of the device to be controlled (Block 134).

When the identity of the controlled device is known or at least some information about the device is known, IR codes for controlling the device may be retrieved from the configurations database 116 or, if the controller is in communication with a computer network (not shown), from a remotely located database (Block 136). The retrieved IR codes may then be tested by the control device (Block 138) and it is determined if the IR are operable to control the controlled device (Block 140). For example, the control device may capture an image of the electronic device that is to be controlled to determine the state of the device and/or if the state of the device has changed when using a particular IR code to perform a particular function (Block 140). This and other related techniques are presented in greater detail in U.S. patent application Ser. No. ______, filed on ______, entitled, “Closed Loop Universal Remote Control,” (Attorney Docket No. P9181US1) which is incorporated herein in its entirety and for all purposes.

If the IR codes are not interoperable, other IR codes may be obtained (Block 136) tested (Block 138). In some embodiments, multiple IR codes are obtained at once and, as such, the obtaining of other IR codes may include simply testing other IR codes that have been obtained.

If the IR codes are interoperable, (e.g., properly control the controlled device), the control device may be programmed with the IR codes (Block 144). Additionally, the control device may be configured to provide or display buttons that correspond to functional commands that may be provided to the controlled device (Block 146). In some embodiments, the buttons may be virtual buttons or physical buttons that are programmed to provide a corresponding command to control the controlled device. In some embodiments, the configuration shape, and appearance of virtual buttons may imitate the configuration, shape and appearance of a dedicated remote control for the controlled device.

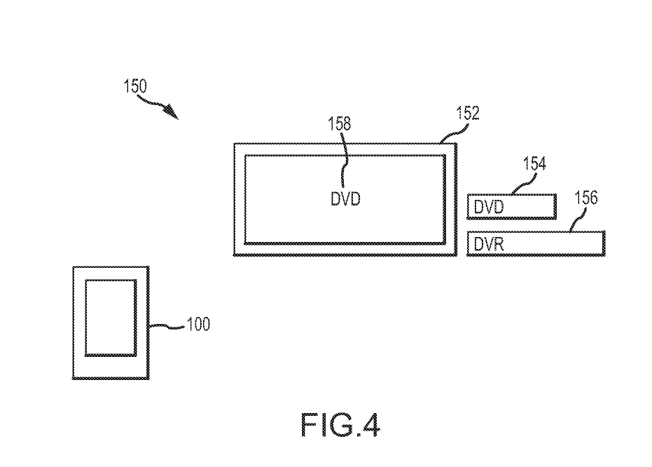

FIG. 4 illustrates an example entertainment system 150 that may include multiple devices that are to be controlled by the control device 100. For example, the entertainment system 150 may include a television 152, a DVD player 154, and a DVR 156. In some embodiments, the control device 100 may capture an image of the system 150 in order to determine the identity of the devices. In some embodiments, the captured image may reveal a brand name, a device type indicator, and/or other markings that may be useful in recognizing the device. The identity of the controlled device may be achieved through processing of an image to recognize logos, characters, shapes, sizes and/or other characteristics. For example, a television having a particular aspect ratio may be recognized based on it proportions and/or its size relative to other objects. A brand name or logo may be recognized for a particular DVD player, or DVR (e.g., TiVo®). Moreover, a shape and/or particular arrangement of a face of a device may be recognized (e.g., a Nintendo Wii® video game console).

In some embodiments, the control device 100 may include a database 116 that may store a range of different identifying characteristics against which collected input data may be compared for identification purposes. In some embodiments, the database 116 may store information for common devices and/or common brands. In some embodiments, the database 116 may provide information for a high level recognition of the devices to be controlled and a more comprehensive database may be accessed for further identification.

In some embodiments, a serial number may be captured in the image and the serial number may be used to identify the device. In some embodiments, a product bar code, UPC code, or the like, may be captured in an image and decoded to identify the device. In some embodiments, media content may be captured to identify the devices. For example, content of a video program may be captured and used to determine that a particular device is a television. In some embodiments, audio may be captured and used to identify the device and or content being provided from the device. In some embodiments, a logo displayed on a television may be used to identify the device. For example, a symbol or logo 158 may be displayed identifying an input device to the television. The logo may be captured with the camera and used to determine the identity of on or more devices and/or what devices are coupled to the television, for example.

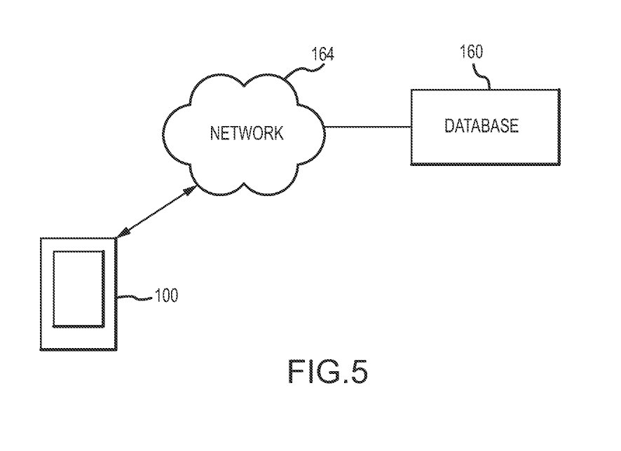

In some embodiments, the control device 100 may be configured with network access capability to help enable accessing a database 160 for identification of controlled devices and/or for obtaining IR codes. FIG. 5 illustrates a simplified network connection between the device 100 and the database 160 via a network 164. It should be appreciated that the network may include wireless and/or wired protocols for the transfer of data. For example, in some embodiments, the control device 100 may be configured with cellular communication capabilities and/or WiFi communication capabilities. In other embodiments, the device 100 may couple with another computer that has network access via Ethernet, cable, fiber optics, or other wired or wireless communication mode. It should also be appreciated that the database may be accessed via a local area network, a wide area network, via the Internet, or other network structure. One or more of the databases 116, 160 may be used in identifying and/or providing IR codes for the controlled devices. Once the device has been identified, the IR codes are obtained by the device 100 and stored in memory 112.

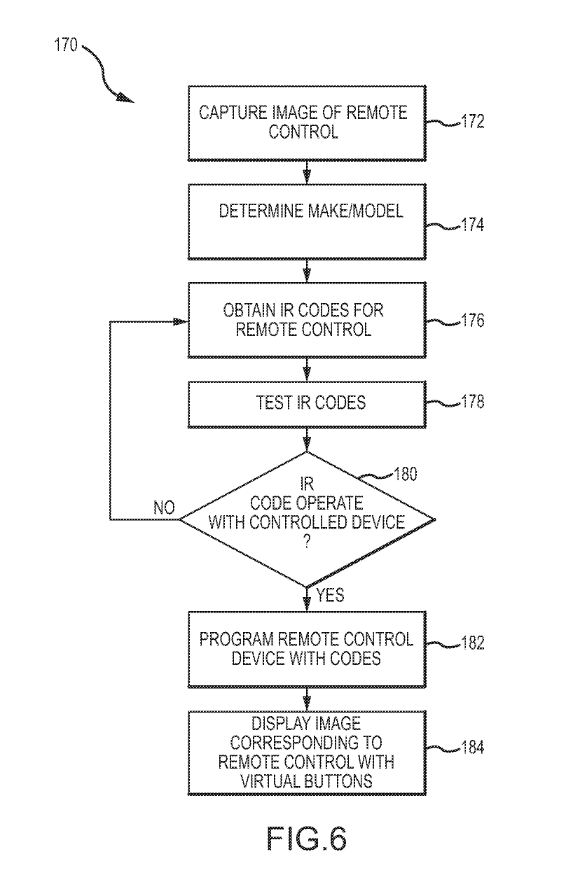

In some embodiments, the identification of a controlled device may be based on an image of a dedicated remote controller or a remote controller provided by a manufacturer of the device to be controlled. FIG. 6 is a flowchart illustrating a method 170 for configuring the control device 100 based on an image of the remote control. Initially, an image of the remote controller is captured (Block 172). Generally, the image of the remote controller may be captured using the camera of the device 100. However, in other embodiments, the image may be obtained in other ways. For example, an image of the remote controller may be capture by another camera and transferred to the device 100 or a user may search and find an image of the remote control using an Internet browser on the control device.

The image of the remote controller is used to determine the make and/or model of the device to be controlled (Block 174). In some cases, this may involve a multi-step process such as first identifying the features of the remote controller, such as the particular button configuration and the type, size, shape, etc. of the buttons, track pad, and/or scroll wheel, and the like. Upon identifying the features of the remote controller, the make and/or model of the remote control may be determined and, subsequently, the make and/or model of the device to be controlled. Generally, remote controls for a particular brand of devices to be controlled may take a similar shape and/or appearance. That is, remote controllers for different televisions made by a particular television brand may have a similar appearance. As such, the identification of the remote control may enable identification of a type of device and/or a brand of the device, but may not be able to identify a particular model. The identification of the remote control and/or the device to be controlled may be achieved through comparisons with information stored in one or more of the databases 116, 160.

Upon identification of the device, or the make of the device, IR codes are obtained. In some embodiments a set of IR codes used for an identified brand may be obtained, while in other embodiments, a reduced set of IR codes may be obtained depending on the ability to narrow the field of possible models of devices. That is, if only a type and brand of device may be determined, more codes may be obtained than if a particular model is identified.

The IR codes are then tested (Block 178) and it is determined if the IR codes are interoperable with the device to be controlled (Block 180). Generally, the testing of the IR codes may include trial and error (or failure) of the obtained IR codes to determine operability of the codes with the device to be controlled. If a particular code does not work, another may be obtained (Block 176) and tested (Block 178). Upon finding operable IR codes, the control device may be programmed with the IR codes (Block 182). Additionally, in some embodiments, the control device 100 may be configured to display an image corresponding to the remote controller with virtual buttons that correspond with the buttons of the controller (Block 184).

It should be appreciated that the more than a single set of IR codes may be provided to the device 100 based on the identity of the controlled device. As such, the device 100 may initiate a test routine to find the appropriate IR code that will control the device.

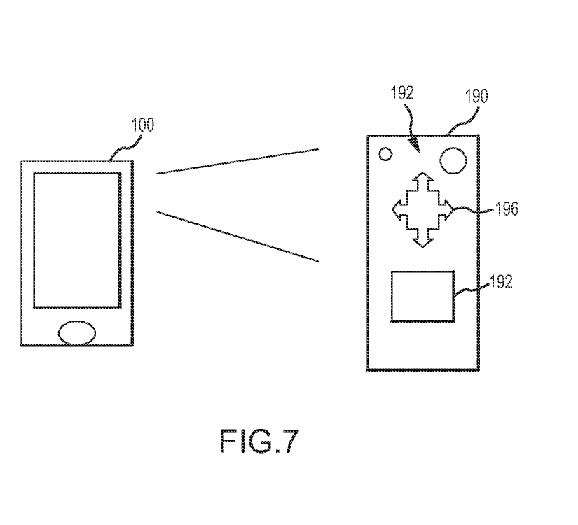

FIG. 7 illustrates the device 100 obtaining an image of a remote controller 190. As shown, the remote controller 190 may include a particular arrangement of buttons 192, a track pad 194, as well as uniquely shaped buttons 196. The arrangement, number, type, and so forth of the buttons may provide for a signature appearance of the remote controller that may be used for identification purposes, as previously described.

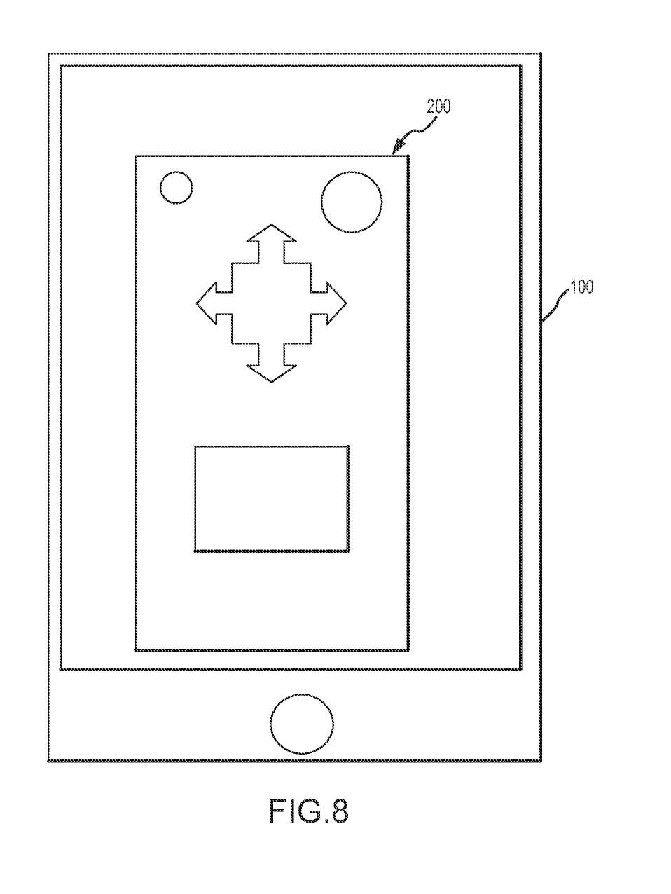

FIG. 8 illustrates the device 100 displaying an image 200 of the remote controller 190. The image 200 may have the same signature appearance as the remote controller 190. Additionally, the displayed image 200 may provide the same functionality as the remote controller 190. That is the device 100 may be configured to create virtual buttons that correspond in both appearance and functionality as the remote controller 190.

In some embodiments, the image 200 may be the image captured by the device 100 for identification purposes. In other embodiments, the image 200 may be obtained from one of the databases 116, 160. In some embodiments, the image and the programming of the virtual button may be obtained from the databases 116, 160. In some embodiments, the programming of the virtual buttons may occur after it is determined what IR codes are operable with the controlled device. The IR codes may be identified as operable and used to particularly identify the controlled device and the databases may provide information related to further programming of the control device to help enable full functionality and interoperability of the control device 100 with the controlled device.

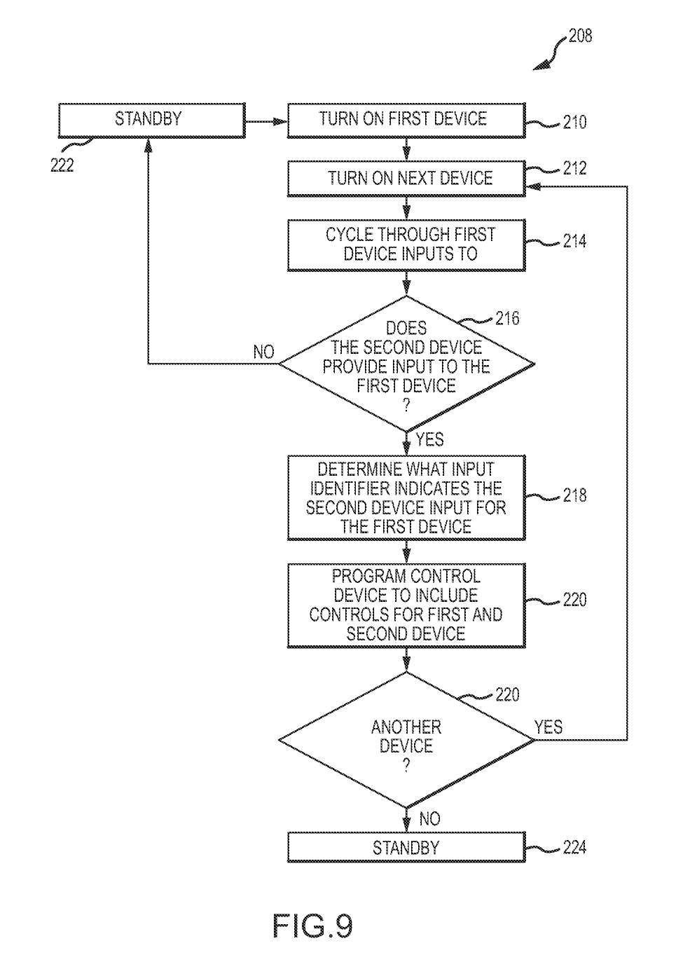

FIG. 9 is a flowchart illustrating an example technique 208 for determining a configuration of a system and programming the control device. The technique includes turning on a first device (Block 210). The first device may be any controlled device, such as a television, a receiver or the like, that is configured to receive input from one or more other devices. A second device is then turned on (Block 212). In some embodiments, the second device may be any device other than the first device that may be controlled by the control device and, furthermore, may provide input to the first device. Each of the first and second devices may be turned on using the control device 100, for example.

The first device may then be cycled through the various input states (Block 214) and it is determined if the second device provides input to the first device (Block 216). If it does not, the control device may return to a standby state (Block 222). However, if the second device does provide input to the first device, it is determined what input identifier is associated with the input from the second device (Block 218). The control device may then be programmed to include controls for the first and second device together (Block 220).

The technique may be repeated to discover if other devices are also coupled with the first device. In particular, the control device 100 may determine if there is another device that may be coupled to the first device (Block 222). The determination may be made by analyzing an image of the entertainment center and using object recognition or other software, perhaps with the databases 116, 160, to determine how if there are more than two devices within the image. If there is an additional device, the process may repeat itself starting at block 212, but with respect to the additional device. If there is no additional device, the control device 100 may enter a standby state (Block 224). Hence, if there are multiple inputs to a television, the control device may be configured to determine that a first device, such as a DVR, is input 1, a second device such as a DVD player is input two and third device such as a video game console is input three.

In some embodiments, the cycling through different input states of the first device may include cycling through a universal serial bus input, an HDMI input, an RGB input, a cable input, and the like. The determination as to whether the second device provides input to the first device may be accomplished by capturing images or audio output of the devices to determine if the first device is providing an output of the second device. Additionally, the programming of the control device to include controls for multiple devices includes providing multiple controls for multiple devices on a single control display of the control device.

In some embodiments, the control device 100 may be configured to determine its location and self-configure based on the determination so that it may control devices in its proximity (e.g., within the room in which the device 100 is located). The location of the control device 100 may be determined using a global positioning system (GPS), proximity sensing, RFID, or other location indication technology. For example, the control device 100 may initially be configured to control a television located in a living room. The control device 100 may be moved to another room in the house, such as a bedroom that has another television. The control device may determine that it is in a new location and further may determine that it is in proximity to a different device for which it may be configured to control and self-configure to control the television in the bedroom.

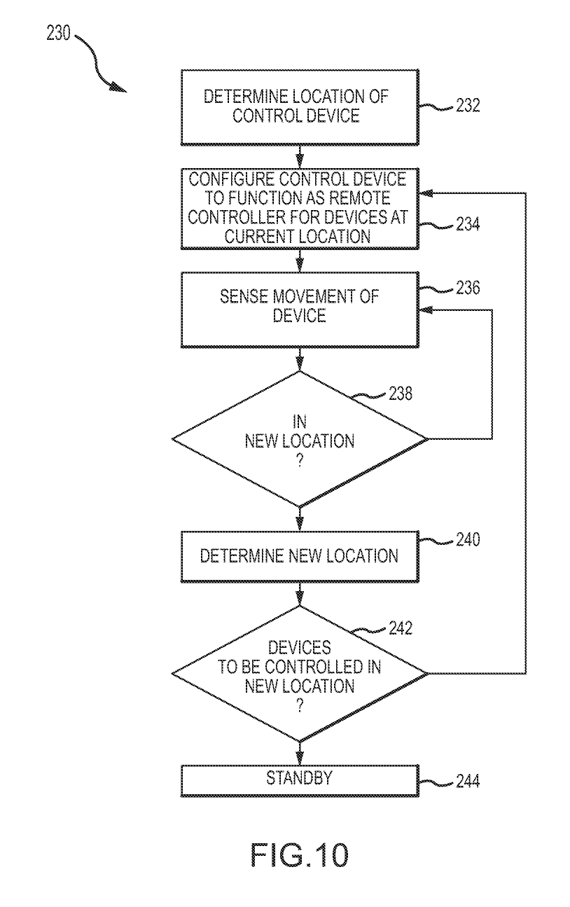

FIG. 10 is a flowchart illustrating an example method 230 for location based, auto configuration of the control device. Initially, the control device 100 may determine its location (Block 232). To determine its location, in some embodiments, the device 100 may be configured with a GPS. In other embodiments, the device 100 may be programmed to recognize its environment and/or a particular device or devices that may indicate a particular location. As such, in some embodiments, the control device 100 may be configured to store one or more images of devices for which it is configured to control. Upon entering into an area, such as a room, with a device, the control device may capture an image and compare it with the stored images and through image recognizing software, may determine its location.

Upon determining its location, the control device 100 may be configured to control the devices in that location (Block 234). The configuration may be based on a prior configuration that has been saved. The prior configuration may include controls for one or more devices. Additionally, the control device 100 may be configured to include one or more controls for multiple devices on a single display concurrently so that multiple devices may be controlled from a single screen.

In some embodiments, the control device 100 may be configured with one or more devices that allow for the determination of movement of the device. For example, the control device 100 may include one or more accelerometers and/or gyroscopes. The may be used to sense movement of the device (Block 236). Upon sensing movement, it may determine if it has been moved to another location (Block 238). If not, then the device may continue to sense the movement and periodically poll a location determining device, such as the GPS to determine if its location has changed. If the location has changed, then the new location is determined (Block 240) and if there are any devices in the new location for which the control device 100 has been configured to control (Block 242). If so, then the control device 100 may be configured to control the devices in the current location by accessing a configuration for that location stored in memory (Block 234). If there are no devices in the new location for which the control device 100 has been configured to control, the control device may enter a standby mode (Block 244). In other embodiments (not shown), the control device 100 may be configured to control devices in the new location and may store the configuration for future reference.

Although several examples referred to using a camera to obtain information about the controlled devices it should be appreciated other inputs may be implemented. For example, in some embodiments, the control device 100 may be configured to listen to the sound emitted from a controlled device to determine what device is proximately located to the control device and/or what content is being provided. For example, the control device 100 may listen (e.g., using a microphone) for particular queues such as a station identifier, show name and/or theme song, advertisements, or other provided content and determines what the content is, what devices are coupled together, and/or what the settings are for the devices (e.g., what input a particular device is for another device).

Additionally, in some embodiments, the control device 100 may self configure to provide supplementary information to a user. In particular, in some embodiments, upon determining what content is on the controlled device (e.g., the television), the control device 100 may provide content on its display to a user aimed at enhancing the user's experience with the content displayed on the controlled device. For example, if it determines a particular movie is on, it may provide a information similar to that which may be found on a movie jacket for the particular movie. In some embodiments, the control device 100 may provide recommendations as to other movies that perhaps are within a genre related to the current movie and/or other supplementary information.

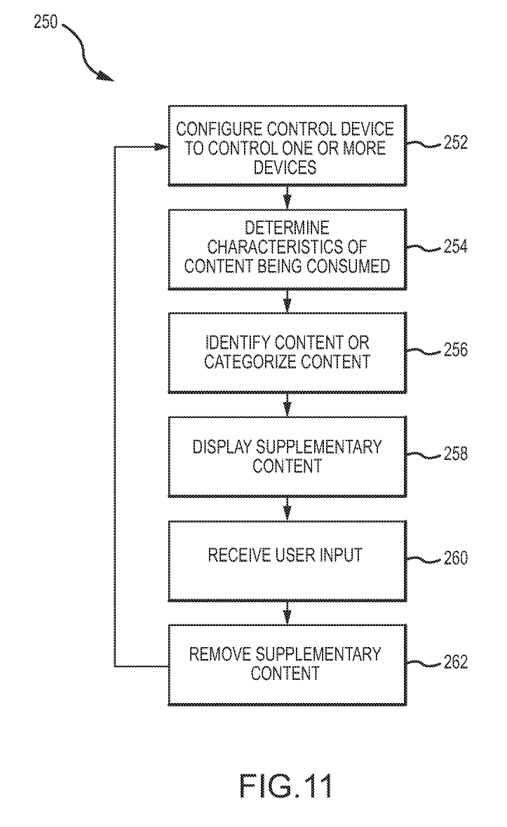

FIG. 11 is a flow chart illustrating an example method 250 for providing supplementary information to a user via the control device 100. The method may begin by the control self-configuring to control one or more devices (Block 252). For example, the control device 100 may self configure based on location or based on an image of a remote controller or a device to be controlled, as discussed above. Upon self-configuring to control one or more devices, the control device 100 may determine characteristics of the content being consumed (Block 254) and may identify the content or categorized the content into a particular genre (Block 256).

For example, the control device 100 may listen to the content and/or capture an image of the content and analyze the content to determine what it is. In some embodiments, identifiers such as a graphical station identifier or program title screen, an audible identifier such as a station identifier, a program theme song, or the actual content itself may be collected and compared to information in the database 160 to determine the content being consumed. For example, a particular theme song may be recognized through audio signature comparisons. Similarly, graphical identifiers may be identified through object/character recognition software and comparison with stored identified that may be indicative of the content or type of content being consumed. With respect to the content itself, names of individuals such as characters in a program or newscasters and/or the content of dialogues may be used to determine the content being consumed. For example, the device may be configured to listen for and recognize certain keywords for which additional content may be provided.

Upon determining what content is being consumed, the control device 100 may display related or recommended supplementary content (Block 256). For example, the device 100 may provide information on the characters, or a synopsis of the content being viewed. In other embodiments, advertisers may pay to provide targeted advertising based on the determined content. In some embodiments, the supplementary content may be displayed with images on a portion of the control device's display that is not being used for buttons of the virtual controller. In other embodiments, the supplementary content may appear after a period of no activity on the control device 100 and serve the additional purpose of a screen saver. Upon receiving input from a user (Block 258), the supplementary content may be removed from the control device 100 (Block 260). For example, if the user changes channels, the supplementary content may no longer be relevant to the current content and therefore may be removed.

The foregoing discussion describes some example embodiments to achieve configurable remote control functionality in an electronic device. Although the foregoing discussion has presented specific embodiments, persons skilled in the art will recognize that changes may be made in form and detail without departing from the spirit and scope of the embodiments. Accordingly, the specific embodiments described herein should be understood as examples and not limiting the scope of the disclosure.

1. A method for configuring a multifunctional electronic device to operate as a remote control, the method comprising:
capturing an image of an electronic device;
comparing the image with data stored in a database;
determining a manufacturer for the electronic device based on one or more identifying characteristics in the captured image;
retrieving information for the electronic device, the information related to remote control of the electronic device; and
configuring the multifunctional electronic device for remote control of the electronic device.

2. The method of claim 1 wherein capturing the image of the electronic device comprises capturing an image of a device that is to be controlled.

3. The method of claim 1 wherein capturing the image of the electronic device comprises capturing an image of a remote controller for a device that is to be controlled.

4. The method of claim 2 wherein the one or more identifying characteristics comprises at least one of a logo, trademark, a brand name, a relative size, and a shape of the one or more devices.

5. The method of claim 2 wherein determining a manufacturer comprises performing character recognition on the image and comparing the recognized characters to manufacturer brand names stored in a database.

6. The method of claim 2 wherein retrieving information comprises obtaining IR codes for the electronic device.

7. The method of claim 6 further comprising:
testing the obtained IR codes; and
determining if a particular IR is interoperable with the device to be controlled.

8. The method of claim 6 wherein obtaining a IR codes comprises accessing a database via a network.

9. The method of claim 1 further comprising determining an input configuration for the electronic device comprising:
turning on the electronic device;
actuating a second device;
cycling through a plurality of input states for the electronic device;
determining if the second device provides input to the electronic device based on the output of the electronic device;
if the second device provides input to the electronic device, configuring the multifunctional electronic device to control the electronic device and the second device from a common control screen.

10. The method of claim 1 further comprising populating a display of the multifunctional electronic device with virtual buttons.

11. A method comprising:
obtaining an image of a remote controller;
identifying at least one device associated with the remote controller and for which the remote controller is configured to control;
retrieving IR codes for controlling the at least one device associated with the remote controller; and
programming a multifunctional electronic device to utilize the IR codes to control the at least one device.

12. The method of claim 11 wherein obtaining the image of the remote controller comprises capturing an image using a camera of the multifunctional electronic device.

13. The method of claim 11 wherein identifying at least one device comprises comparing the obtained image with images from a database to determine one of a manufacturer of the at least one device and a model of the at least one device.

14. The method of claim 11 wherein retrieving IR codes comprises obtaining IR codes from at least one of a local database and remote database.

15. The method of claim 11 wherein programming the device to utilize the IR codes comprises:
testing the IR codes for interoperability with the at least one device;
retrieving additional IR codes if the tested codes are not interoperable with the at least one device; and
programming the multifunctional electronic device with IR codes that are interoperable with the at least one device.

16. The method of claim 11 further comprising displaying the obtained image on a display of the multifunctional electronic device.

17. The method of claim 12 further comprising configuring the displayed image with virtual buttons that correspond to the buttons of the remote controller.

18. The method of claim 11 wherein identifying at least one device comprises:
recognizing a signature appearance of the remote controller; and
correlating the signature appearance with the at least one device by searching a database for the signature appearance, wherein the database comprises signature appearance information correlated with device information.

19. A method comprising:
determining a location of a control device;
configuring the control device to control devices in the location;
sensing movement of the control device;
determining if the control device is in a new location;
if the control device is in a new location, identifying the new location;
determining if controllable devices are located in the new location;
configuring the control device to control the controllable devices in the new location.

20. The method of claim 19 wherein configuring the control device to control the controllable devices in the new location comprises:
capturing an image of the devices in the new location;
identifying the devices in the new location;
retrieving information for control of the controllable devices from a database; and
using the retrieved information to configure the control device to control the controllable devices in the new location.

21. The method of claim 20 further comprising:
storing configuration information for the new location; and
associating the stored configuration information with the new location.

22. A multifunctional electronic device comprising:
an input device configured to obtain information related to a remote controllable device;
a processor coupled to the input device and configured to process the obtained information to identify the remote controllable device;
a memory coupled to the processor, the memory storing information for identification of the remote controllable device and information for configuring the multifunctional electronic device to control the remote controllable device;
a touch screen display for providing virtual buttons to obtain user input for control of the remote controllable device; and
a transmission device for transmitting control commands to the remote controllable device.

23. The multifunctional electronic device of claim 22 further comprising a wireless communication device for accessing a database via a network to obtain information related to identification and control of the remote controllable device.
